(19) United States
(12) Patent Application Publication
(10) Pub. No.: US 2022/0318451 A1
(43) Pub. Date: Oct. 6, 2022

(54) SCALABLE SIMULATION PLATFORM FOR POWER TRANSFORMERS RATING, LOADING POLICY, AND THERMAL PERFORMANCES EVALUATION

(71) Applicant: METLAB RESEARCH INC., Montreal (CA)

(72) Inventor: Therence METON, Lachine (CA)

(21) Appl. No.: 17/447,462

(22) Filed: Sep. 13, 2021

Related U.S. Application Data
(60) Provisional application No. 63/200,865, filed on Mar. 31, 2021.

(51) Int. Cl. G06F 30/20

(52) U.S. Cl. CPC G06F 30/20; G06F 2119/08

(57) ABSTRACT

There is provided a scalable simulation platform, comprising means for rating a power transformer, means for setting a loading policy for a transformer, and/or means for evaluating the thermal performances of a transformer.

### CROSS REFERENCE TO RELATED APPLICATIONS

This application claims benefit of U.S. Provisional Patent Application No. 63/200,865, filed on Mar. 31, 2021, the content of which is incorporated herein in its entirety by reference.

### FIELD OF THE INVENTION

The present invention relates to a scalable simulation platform for power transformers rating, loading policy and thermal performances evaluation. The simulation platform according to the invention (also referred to herein as the LoadingHub™) is aimed at the various power system actors involved in the decision-making process. The invention also relates to a ubiquitous transformer nameplate. In embodiments of the invention, the simulation platform and the transformer nameplate are cloud-based.

### BACKGROUND OF THE INVENTION

Power transformers undergo different load cycles that vary depending on the time of the day, the time of the year as well as operating conditions. Typically, the daily load cycle tends to increase during the early hour of the morning before people leave to work, and in the evening after they arrive home. Similarly, a yearly load cycle will be higher during the hot summer months when high ambient temperatures cause consumer to ramp-up their air conditioners and use more electrical power. Industrial loads can be continuous or cyclical and superimposed over residential loading. Additionally, the integration of electric vehicles and distributed energy resources in the power grid inject some non-linear loads that are now being superimposed over both residential and industrial loads. This new situation dictates the need to assess transformers readiness to withstand dynamic fluctuating load. Also, this new situation requires the adoption of flexible loading criterion that may include different loading scenarios to be simulated for temperature and loss of life considerations.

During emergency conditions, single or various network components such as a transmission line, a generator or a transformer might become isolated from the power system. Especially, power transformers can become overloaded above their maximum nameplate rating and be subjected to overheat and high stress on their insulation system. Overloading means the extra power delivered comes with the cost of higher temperature levels and accelerated aging. Furthermore, the prevalence of a high level of moisture and oxygen ingress combined with the thermal hot spot in the context of operation beyond nameplate rating may worsen the damage to the insulation system and shorten the transformer life. Therefore, transformer overload must be studied and analyzed carefully to avoid risks, prevent damage, and minimize the insulation loss-of-life.

Transformer overload has been a subject of studies by researchers and engineers with published literatures such as the IEEE C57.91 [1] and IEC 60076-7 [2] loading guides. These guides describe how transformers can be rated higher than their nameplate ratings for continuous, long term, and short-term emergency conditions if certain criteria are applied. Unfortunately, the combination of the loading guides with daily operation constraints presents unique challenges to transmission and distribution (T&D) operators regarding the effective application of the prescribed recommendations.

On the factory floor, the transformer heat-run final test is conducted at nominal ambient temperatures, usually different from the real world ambient operating conditions. Furthermore, after commissioning, little evidence is collected on behalf of the manufacturer on how the transformer operates under varying loads and ambient conditions. On the receiving end, the heat-run test report delivered during commissioning gets lost, especially for older units still operating on the field. Most of the time when it comes to assessing the transformer load-ability, parameters valued must be guessed or duplicated from sister units.

Attempts to address these challenges have resulted in various forms of software tools and the creation of excel sheets. These solutions operate on the premise that factory final test results are known, opening avenue to educated guess estimates when the need arises to define a proper transformer loading policy, or when a capacity upgrade is required from a transformer to deliver additional load. On the top of it all, the most notable tools [3] used today in the power T&D industry for transformer load assessment are designed to run on dedicated hardware using static provisioning. Although they might support distributed simulation, they do not provide direct support for running on a cloud infrastructure, do not cover original equipment manufacturers (OEMs)′ needs to simulate their transformer loading capability and thermal performances upgrade on the factory floor, and lack the scalability needed to simulate a broad range of loading scenarios and operating modes and conditions.

Three levels of constraints shape the T&D operator definition of a proper loading policy for specific unit, or for a fleet of transformer units: (a) the first layer falls under the new North American Electric Reliability Corporation (NERC) standards FAC-008 [4] which requires T&D utilities to provide documentation and proofs for their rating methodology of power systems elements; (b) the second layer comes in the form of loading policies recommendation from the IEEE and IEC loading guides which describe how transformers can be rated higher than their nameplate ratings for continuous, long term, and short-term emergency conditions if certain criteria are applied; (c) the third layer is shaped by the daily operation constraints faced by the T&D systems operator, especially with the economic pressure to use units closer to their full rating capacity and beyond, pressure guided by the need to serve growing industrial areas and the integration of renewable sources of energy.

Conventionally when the transformer is commissioned, a document labelled as the “Heat-Run Factory Final Test Results” specifying the tests conducted in the factory and their results must be provided by the manufacturer. According to the IEEE C57.12 [5] and IEEE C57.154 [6] standards, the following transformer parameters are presented in the test report:
No-load loss (kW), excitation current (per-unit of specified MVA ratings),
Load losses (kW), Impedance, Reactance (per-unit on specified MVA rating),
Zero sequence test results.

Conventionally, the transformer has a printed or stamped stainless steel nameplate attached to the tank that provides basic information about the transformer. IEEE C57.12 [5] details the information that must be shown on a transformer nameplate depending on the type and kVA rating of the transformer. According to the IEEE standard, the nameplate should have the following information:
Serial number, month/year, name, type, and location of manufacture;
Number of phases, frequency, MVA rating, voltage rating, tap voltages, polarity or single-phase transformers or vector diagram for multi-phase transformers, percent impedance, conductor material, winding connection diagram;
Cooling class, temperature rise, type of insulation liquid, liquid volume or tank volume, pressure, and liquid data;
Type of insulation system, rated average winding temperature rise, rated hot spot temperature rise (for each winding), rated top liquid temperature rise, type of liquid by generic and trade name;
Insulation for installation and operation, total weight, and basic insulation level (BIL).

Conventionally, transformers are rated based on the output delivered continuously at a specified rated voltage and frequency under the nominal operating condition without exceeding the internal temperatures defined in [1]. Transformers may also be rated based on input power, generally specified in mega volt amp (MVA). An example of such rating may be as follows:
Ambient air temperature not to exceed 40° C., average ambient temperature in any 24 h period not to exceed 30° C.
Top oil temperature not to be less than −20° C.
Maximum altitude 1000 m
Maximum top liquid temperature (° C.)
   normal life expectancy,
   above nameplate rating
Maximum solid insulation hottest spot temperature (° C.)
   Normal life expectancy,
   Planned loading beyond nameplate rating,
   Long-time emergency loading,
   Short-time emergency loading

The nameplate suggests nominal values of operation parameters, labelled as rated values recorded at rated ambient conditions, as well as limitations not to exceed to maintain safe operation per the IEEE/IEC standards.

There is a need for more reliable and efficient simulation platforms for power transformers rating, which would help the various power system actors involved in the decision-making process. Also, there is a need for more efficient transformer nameplates.

### SUMMARY OF THE INVENTION

The inventor has designed a scalable simulation platform for use in the rating, the setting of loading policy, and the evaluation of thermal performances of power transformers. The various power system actors involved in the decision-making process, such as transmission and distribution (T&D) operators, receive prescribed recommendations more efficiently, which leads to an effective application thereof. In embodiments of the invention, the simulation platform or LoadingHub is adapted to be run on cloud infrastructure.

According to an embodiment, the invention relates to a ubiquitous transformer nameplate. A digital infrastructure is associated thereto, which moves the transformer nameplate from its traditional passive role to a dynamic virtual infrastructure. In embodiments of the invention, the ubiquitous transformer nameplate is cloud-based.

According to another embodiment, the invention relates to a system comprising the scalable simulation platform of the invention and/or the ubiquitous transformer nameplate of the invention. In embodiments of the invention, the system is cloud-based.

The invention thus provides the following in accordance with aspects thereof:
(1) A scalable simulation platform, comprising means for rating a power transformer, means for setting a loading policy for a transformer, and/or means for evaluating the thermal performances of a transformer.
(2) The scalable simulation platform according to (1), which is adapted for simulating: heat-run test configurations, loading capability, thermal performances, capacity upgrade, and combinations thereof.
(3) The scalable simulation platform according to (1) or (2), comprising: a front-end server, a simulation designer, a database and file bucket, and a simulation server.
(4) The scalable simulation platform according to (3), wherein the front-end server is adapted for coordinating actions between power system actors involved in the decision-making process; preferably the actions are selected from the group consisting of: authentication, transformer registration, data streaming and formatting, and simulation initialization and monitoring.
(5) The scalable simulation platform according to (4), wherein the power system actors are selected from the group consisting of: maintenance and planning engineers, load dispatchers, high voltage asset managers or owners, original equipment manufacturers (OEMs), and transformer monitoring service providers.
(6) The scalable simulation platform according to (3), wherein the simulation designer is a web console embodying model constructs; preferably the model constructs are selected from the group consisting of: transformer dynamic datasheet, loading scenario modeler, and virtual transformer designer.
(7) The scalable simulation platform according to (3), wherein the database and file bucket is adapted for storing at least one of: metadata associated with all user accounts and application programming interface (API) keys, simulation experiments metadata, and data streamed from external sources; transformer profiles; and simulation results.
(8) The scalable simulation platform according to (3), wherein the simulation server embodies one or more simulation clusters.
(9) The scalable simulation platform according to any one of (1) to (8), which is cloud-based.
(10) A method for rating a power transformer, for setting a loading policy for a transformer, and/or for evaluating the thermal performances of a transformer, the method comprising simulation of one or more of: heat-run test configurations, loading capability, thermal performances, and capacity upgrade.
(11) A method for rating a power transformer, for setting a loading policy for a transformer, and/or for evaluating the thermal performances of a transformer, the method comprising using the scalable simulation platform as defined in any one of (1) to (9).
(12) Use of the scalable simulation platform as defined in any one of (1) to (9), for rating a power transformer, for setting a loading policy for a transformer, and/or for evaluating the thermal performances of a transformer.
(13) A ubiquitous transformer nameplate, which embodies a digital infrastructure system allowing for the transformer nameplate to be moved from its traditional passive role to a dynamic virtual infrastructure.
(14) The ubiquitous transformer nameplate according to (13), wherein the digital infrastructure system comprises:
   means for allowing power system actors to register their transformers on a digital portal (preferably the digital portal is cloud-based), preferably with their conventional nameplate and heat-run test report, and accessories data such as liquid ad winding temperature indicator;
   means for allowing the power system actors to submit their loading policy requirements to obtain the determination of an optimal loading policy that reliably suits their continuous operation;
   means for enabling a continuous verification of transformers ratings compliances against the guidelines enacted by regulatory bodies, and deliver a digital certificate of compliancy for audit;
   means for delivering daily/weekly/monthly load forecast notifications to the actors or designated recipients, with the help of location weather data, and custom load profile; and/or
   means for allowing the tracking of the performance of commissioned transformers' thermal performances before and on site after commissioning, on the operation theater.
(15) The ubiquitous transformer nameplate according to (13) or (14), wherein the digital infrastructure system comprises: a portal adapted for the registration of transformers; and a simulation server embodying a nameplate calculation center (NCC).
(16) The ubiquitous transformer nameplate according to (15), wherein the nameplate calculation center comprises:
   means for generating a QR code for each transformer;
   means for conducting the load forecast calculation and the thermal performance evaluation of the transformer;
   means for generating a comprehensive forecast report for the actors; and/or
   means for executing a notification and delivery schedule.
(17) The ubiquitous transformer nameplate according to any one of (14) to (16), wherein the power system actors are selected from the group consisting of: maintenance and planning engineers, load dispatchers, high voltage asset managers or owners, original equipment manufacturers (OEMs), and transformer monitoring service providers.
(18) The ubiquitous transformer nameplate according to any one of (13) to (17), which is cloud-based.
(19) A system comprising the scalable simulation platform as defined in any one of (1) to (9) and/or the ubiquitous transformer nameplate as defined in any one of (13) to (18).
(20) The system according to (19), which is cloud-based.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1: LoadingHub top-level system architecture.

FIG. 2: The virtual transformer modeler.

FIG. 3: Example of load profile definition. (a) Total load demand of EV battery chargers at 25% Ev penetration rate. (b) Transformer load profile. (c) Winter residential load.

FIG. 4: Simulation kernels.

FIG. 5: Orchestration process (ORP) functional model.

FIG. 6: Background workers (BW) functional model.

FIG. 7: Simulation process flow.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein when referring to numerical values or percentages, the term “about” includes variations due to the methods used to determine the values or percentages, statistical variance and human error. Moreover, each numerical parameter in this application should at least be construed in light of the number of reported significant digits and by applying ordinary rounding techniques.

The inventor has designed a scalable simulation platform for use in the rating, the setting of loading policy, and the evaluation of thermal performances of power transformers. The various power system actors involved in the decision-making process, such as transmission and distribution (T&D) operators, receive prescribed recommendations more efficiently, which leads to an effective application thereof. In embodiments of the invention, the simulation platform or LoadingHub is adapted to be run on cloud infrastructure.

According to an embodiment, the invention relates to a ubiquitous transformer nameplate. A digital infrastructure is associated thereto, which moves the transformer nameplate from its traditional passive role to a dynamic virtual infrastructure. In embodiments of the invention, the ubiquitous transformer nameplate is cloud-based.

According to another embodiment, the invention relates to a system comprising the scalable simulation platform of the invention and/or the ubiquitous transformer nameplate of the invention. In embodiments of the invention, the system is cloud-based.

The scalable simulation platform according to the invention or LoadingHub platform is a cloud-based discrete event simulator designed to create virtual power transformers models of all types to simulate their heat-run test configurations, loading capability, thermal performances, and capacity upgrade. The platform provides a scalable alternative to the traditional on-premises solutions which are still the industry standard. The simulator outlines guidelines to develop proper transformer loading policies, and enables mechanisms that answer key questions asked by power systems actors regarding the amount of energy a transformer unit can reliably carry without violating safety and operation constraints at various levels, namely: (a) transmission and distribution operations constraints at the utility level; (b) the loading guides prescription from the IEE and the IEC loading guides [1-2]; (c) the NERC transformer ratings compliancy. The platform targets the following power system actors: maintenance and planning engineers, load dispatchers, asset managers, original equipment manufacturers (OEMs), and transformer monitoring service providers.

### I. The LoadingHub Platform Architecture

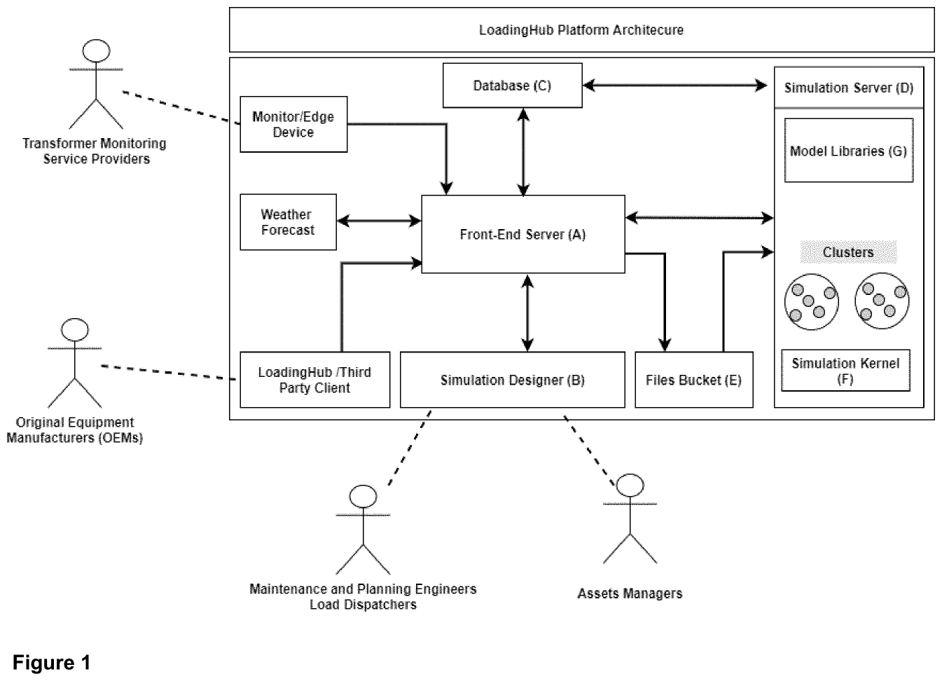

The platform is built on the foundation of virtual transformer models used to simulate the behaviour of the transformer under a wide variety of user-defined operating scenarios. The foundational top-level architecture surrounded by the targeted power systems actors listed herein above is shown in FIG. 1.

### II. The Front-End Server

The front-end server which is at the heart of the platform is responsible for the coordination of all actions between the various entities making up the architecture. Especially, the font-end server performs the following actions: authentication, transformer registration, data streaming and formatting, simulation initialization and monitoring.

### A. Authentication

The front end server provides two types of authentication depending on the data source: (a) when using the simulation designer for the first time, the user must sign-in and obtain the necessary credentials granting access to the platform resources; (b) the front-end server also exposes an application programming interface (API) allowing third-party tools or equipment (transformer monitors, LoadingHub clients) to obtain a key for authentication prior to sending or streaming data into the platform.

### B. Transformer Registration

When the authentication got passed, the front-end server allows the registration of transformer units with the help of their heat-run factory final test results (FFTR) and nameplate drawing. A transformer datasheet is then generated and sent back as acknowledgement of the registration success. The transformer registration is mandatory for the platform to allow any experiment design.

C. Data streaming and formatting

Transformer FFTR and nameplate data, user defined loading scenarios, virtual transformer model specifications, and edge devices data are compiled, formatted and subjected to a proper validation prior to storage. When an experiment design requires data streams from a client (edge device, weather server, or third-party tool), the front-end server is responsible for initiating an on-demand handshake. Transformer measurements data streamed from the client must minimally include ambient temperature, load, moisture level, cooling power and status, and incidentally, dissolved gas levels.

### D. Simulation Initialization and Monitoring

When a simulation experiment design is completed and submitted, the front-end server is responsible for: (a) generating a stimuli file that is stored in the simulation file repository; (b) sending the simulation request to the simulation server, with an indication of the stimuli file location on the simulation files repository. The front-end server is also responsible for inquiring the simulation server about the status of the simulation run, and logs heartbeat messages regarding the progress of the simulation.

### III. The Simulation Designer

The simulation designer is a web console allowing the user to perform the basic tasks and settings required to operate a simulation session. The designer relies on model constructs such as the transformer dynamic datasheet, the loading scenario modeler, and the virtual transformer designer.

### A. The Dynamic Datasheet

The transformer heat-run factory final test report is a compilation of attribute-value pairs serving the purpose of certifying the transformer nominal operating conditions. These values are traditionally set to be constant and describe experiment made in factory to come up with a nominal operation value. The LoadingHub platform introduces a rather flexible approach with the “dynamic datasheet” allowing the datasheet attributes values to be specified either as a range of values or a probability distribution for numerical attributes. The dynamic datasheet in Table 1 below shows an example of a two-stage transformer dynamic datasheet where some attributes are modelled as normal distribution while some others are picked up from a value set. Numerical distribution can be picked up as normal, uniform, or any other user-defined distribution, if the user is able to specify the parameters that best reflect the attributes known behaviour. Attributes listed in the dynamic datasheet complies also with the recommendations set forth by the IEEE and IEC transformers loading guides [1-2]. The dynamic datasheet is especially useful when the heat-run test report delivered during commissioning got lost, which is usually the case for older transformer units still operating on the field, or when an original equipment manufacturer (OEM) for better design reduction impacts with high-temperature insulations. Most of the time when it comes to assessing the transformer load-ability, parameters value must be guessed or duplicated from sister units which rated parameters are known.

TABLE 1
Example of a transformer dynamic datasheet.

| Parameter | | | |
|---|---|---|---|
| Description | 1st Stage | 2nd Stage | Unit |
| Cooling modes | ONAN | [ONAF, ODAF, | — |
| | | OFAF, etc . . . ] | |
| kVA base for losses | 180000 | 300000 | kVA |
| Temperature base for | {80, 85} | {80, 85} | ° C. |
| losses at this kVA | | | |
| I2R losses, PW, | [symbol] (241,274, 5000) | [symbol] (673000, 5000) | Watts |
| watts | | | |
| Winding eddy losses | [symbol] (24,737, 600) | [symbol] (69000, 600) | Watts |
| Stray losses, PS, | 21,510 | [symbol] (60000, 500) | Watts |
| watts | | | |
| Core loss, Pc, r, | 88000 | 88000 | Watts |
| watts | | | |
| One per unit kVA | 180000 | 300000 | kVA |
| base for load cycle | | | |
| Rated average | {55, 65} | {55, 65} | K |
| winding rise | | | |
| over ambient | | | |
| Tested or rated | [symbol] (43, 3) | [symbol] (65.1, 3) | K |
| average winding | | | |
| rise over ambient | | | |
| Tested or rated | [symbol] (61.8, 3) | [symbol] (73.6, 3) | K |
| hot-spot rise | | | |
| over ambient | | | |
| Tested or rated top | [symbol] (48.7, 3) | [symbol] (55.6, 3) | K |
| oil rise over ambient | | | |
| Tested or rated | [symbol] (17.1,2) | [symbol] (51.2,3) | K |
| bottom oil rise | | | |
| over ambient | | | |
| Per unit eddy loss at | [1.3, 1.6] | — | — |
| winding hot-spot, | | | |
| EHS | | | |
| Liquid insulation | [MINERAL, ESTER, | — | — |
| type | SILICON] | | |
| Solid Insulation | [KRAFT, KRAFT- | — | — |
| type | UPGRADED, | | |
| | POLYIMIDE, | | |
| | POLYESTER, | | |
| | ARAMID, etc.] | | |
| Winding time | [5, 10] | — | Min. |
| constant | | | |
| Per unit winding | [symbol] (1, 0.5) | — | — |
| height to hot spot | | | |
| Weight of core and | [312000, 400000] | — | lb |
| coils | | | |
| Weight of tank and | [210000, 280000] | — | lb |
| fittings | | | |
| Gallons of fluid | 16216 | — | US |
| | | | Gallons |
| Number of fans | 0 | [1, 8] | — |
| Number of radiators | 5 | — | — |
| Fan cooling power | [2500, 3500] | — | Watts |
| Fan rotation speed | [950, 1240] | — | rpm |

### B. The Loading Scenarios Modeler

The loading scenarios model an interrogation, or a set of interrogations set forth by actors to express transformers loading policy constraints in terms of relationships established between attributes, operators, and value(s). The interrogations are related to design assessment, daily normal or emergency situations, as well as long-term, short-term CAPEX planning. Table 2 below provides a sample of such interrogations.

TABLE 2
Sample interrogations set forth by actors.

Are we operating units within FERC/IEEE/IEC
and company loading policy?
What marginal load capability is available at
today's peak ambient temp?
What is the maximum load at the current
ambient temperature?
Which units are at full potential in normal
and emergency modes?
How much margin or time is there before
units needs to be replaced?
What impact will global warming have
on my transformer fleet?
Do we have a cooling problem? How long
has it been, or can we operate like this?

The simulation goals and custom requirements expressed in terms of interrogations in the light of the instances presented in Table 2, are modelled as a set s={ [symbol] a₁, o₁, v₁ [symbol] . . . [symbol] zₙ, oₙ, vₙ [symbol] } of tuples of properties defining a single or set of loading scenarios. A set of default attributes aᵢ are presented in Table 3 below. Operators oᵢ denotes the relational operators, and vᵢ a set of real, integer or categorical values. Table 4 below presents an example of a loading scenario. Let E={s₁, s₂, . . . sₘ} denotes the set of loading scenarios.

TABLE 3
Default list of loading scenario attributes.

| Attributes Description | Unit |
|---|---|
| Main tank attributes | |
| Top oil temperature limits | — |
| Hot spot temperature limits | ° C. |
| Bottom oil temperature limits | ° C. |
| Bubbling temperature limits | ° C. |
| Permissible load limits | p.u. |
| Loss of life rate limits | Watts |
| Solid insulation lifetime | Hours |
| Total combustible gas limits | ppm |
| Tap changer | |
| Tap changer position | — |
| Total contact temperature limits | ° C. |
| Max load through the LTC | p.u. |
| (in per unit of LTC current | |
| rating) | |
| Bushing | |
| Max load through the bushings | p.u. |
| (in per unit of busing current | |
| rating) | |
| Bushing insulation hottest-spot | ° C. |
| temperature limits | |
| Water activity in oil | p.u. |
| Cooling | |
| Number of active coolers | — |
| Noise emissions limits | dB |
| Cooling power limits | Watts |
| Miscellaneous | |
| Time for load duration | Hours |
| Load for time duration | p.u. |
| Altitude | meters |

TABLE 4
Example of a loading scenario setup by utility engineers.

| Attribute | Operator | Value | |
|---|---|---|---|
| Top oil temperature limits | ≤ | 110° | C. |
| Hot spot temperature limits | ≤ | 140° | C. |
| Bubbling temperature limits | ≤ | 150° | C. |
| Permissible load limits | ≤ | 2.0 | p.u. |
| Loss of life rate limits | < | 2% | |
| Solid insulation lifetime | = | 65000 | |
| | | Hours | |
| Load level when the hydrogen (H₂) | = | 25 | ppm |
| gas peak was detected | | | |
| Tap changer position | = | Unchanged, | |
| | | Rated | |
| Water activity in oil | = | 0.05 | p.u. |
| Start time of the overload period | = | 6:00 | PM |

| | | |
|---|---|---|
| Load for time duration | = | 2 Hours |

### C. The Virtual Transformer Modeller

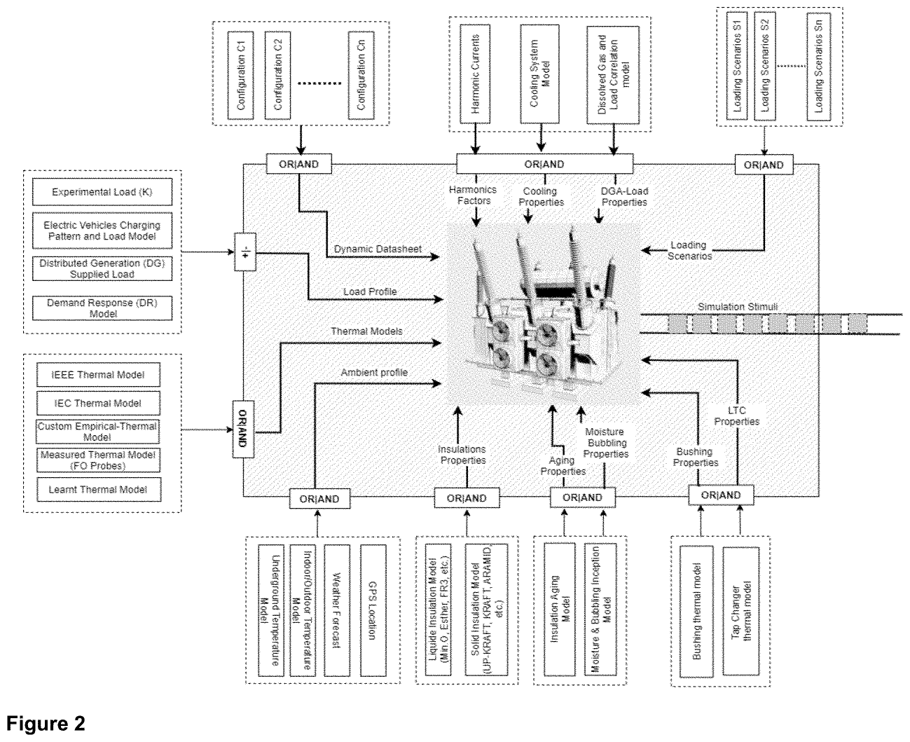

The virtual transformer modeller (VTM) is a logical construct made of components that mimic the transformer physical status and behaviours that affect its overall ability to safely carry the load required for the system operation. The VTM is represented as a panel allowing actors to select, drag, drop, and specify logical models' properties. The logical components are chosen according to the simulation goals. Some of them are mandatory while others are not. The transformer is broken down in pre-built functional components, which, put together as depicted in FIG. 2, define the simulation experiments. Each functional component is characterized by a set of properties made of pairs (attribue, operator, value).
(a) The transformer profile: it describes the transformer prototype under consideration for the simulation experiment. The transformer profile is characterized by a set of properties showcasing the application context the equipment is designed to operate within. These properties are outlined in Table 5 below.

TABLE 5
Properties of the transformer identification component.

| Attribute | Definition |
|---|---|
| Unique identifier | Unique equipment identifier, serial number |
| GPS location (altitude, | Physical location coordinates |
| latitude, longitude) | |
| Transformer type | Power, distribution, regulating, etc. |
| Date placed in service | When the transformer has been put in service |
| Transformer size | Transformer MVA rating |
| Overload capability | Percentage of load capacity beyond |
| | nameplate rating |
| Voltage class | Class1(<110 kV), Class2(110-220 kV), |
| | Class3(>220 kV) |
| Sealing method | nitrogen blanket, conservator, free breather, |
| | etc. |
| Vendor | Transformer manufacturer, application type |

(b) Insulation models: This functional component models the transformer insulation types (liquid, solid, gas, vacuum). Especially with the increasing use of high-temperature liquids and solid insulating materials [6] in transformer design, the insulation models offer unique perspective for the impact analysis of their properties on the transformer loading and thermal performances. The properties outlined in Table 6 below minimally describes both liquid and solid insulation.

TABLE 6
Properties of the insulation materials [6].

| Attribute | Definition |
|---|---|
| Liquid insulation type | {Mineral oil, natural esther, |
| | silicon, etc.} |
| Thermal class | Estimated thermal class |
| Flash point | Lowest temperature at which the |
| | vapor pressure is sufficient to form |
| | an ignitable mixture with air near the |
| | surface of the liquid |
| Fire point | Lowest temperature at which the |
| | liquid insulation attains sufficient |
| | vapor pressure to continue to burn |
| | once ignited |
| Density@ 25° C. | |
| Relative permittivity @25° C. | |
| Dissipation factor@25° C. | |
| Kinematic viscosity (mm²/sec) | |
| Thermal conductivity | |
| at 25° C. (W/mK) | |
| Liquid constants | Constants (A, B) |
| Solid insulation type | KRAFT (55), TU-KRAFT, Aramid, |
| | etc. |
| Thermal class | Maximum daily hot spot |
| | temperature |
| Moisture absorption (%) | |
| Dissipation factor (%) | Dissipation factor at @25° C. and |
| | @100° C. |
| Density (g/cm³) | |

(c) Thermal models: This component is always required in a simulation experiment. Thermal models exist on various forms, with the mains provided by the IEEE C57.91 [1] and the IEC 60076-7 [2] loading guides. With the advent of fiber probes being increasingly part of the transformer windings structures, thermal models can now be learned from data reported by embedded probes. Inferred thermal models from data generated by probes presents new opportunities to bypass model-driven and empirical models. Attributes reported in the thermal models are calculated from other models' attributes. The thermal model functional component exposes the properties outlined in Table 7 below.

TABLE 7
Properties of the thermal functional model.

| Attribute | Definition |
|---|---|
| Thermal model scheme | IEEE Clause 7, IEEE Annex G, IEC60067, |
| | Utility-based, OEM-based, Learned, etc. |
| Thermal history file | Transformer thermal history (optional) |
| Ambient temperature | History of the ambient temperature at the |
| | transformer site |
| Top oil temperature | History of the liquid insulation temperature |
| | at the top of the tank. |
| Hot spot temperature | History of the temperature at the hottest |
| | point in the windings |
| Bottom oil temperature | History of the temperature of the oil at |
| | the bottom of the tank. |
| Load | History of the transformer load capacity |
| | relative to the rated load |
| Water activity | History of the water activity in oil |

(d) Moisture and bubbling temperature model: This functional component is not mandatory, although the inclusion of moisture as input to the calculation of the insulation aging leads to a more accurate estimate of the transformer loss of life. The associated properties are outlined in Table 8 below.

TABLE 8
Properties of the moisture and bubbling evolution functional model.

| Attribute | Definition |
|---|---|
| Bubblin model scheme | IEEE, McNuttt, Oomen, custom |
| Water activity | Reported water activity in the |
| | liquid insulation |
| Oil breakdown voltage (kV) | Breakdown strength of the |
| | liquid insulation |
| Board breakdown voltage (kV) | Breakdown strength of the |
| | solid insulation |
| Gas content (%) | Gas content in % |
| Gas pressure (kPa) | Vapor pressure of gases |

(e) Insulation aging model: the transformer insulation loss of life can either be calculated exclusively with the windings hottest spot temperature, or the combination of temperature, moisture, and oxygen level in the insulating systems. Thus, the insulation aging functional model exposes the properties outlined in Table 9 below.

TABLE 9
Properties of the insulation aging functional model.

| Attribute | Definition |
|---|---|
| Lifetime | Normal Insulation Lifetime |
| Service age | Transformer age since commissioning |
| Water content in paper | Given value or calculated Water |
| | content in the solid insulation |
| Oxygen content | Oxygen level in the main transformer |
| | main tank |
| Hot spot temperature | Specify whether the hottest temperature |
| | is calculated or measured |

(f) Cooling system model: This component is mandatory for the simulation experiment design, especially for the loss of cooling power and the simulation of cooling capacity upgrade. Some of the properties presented in Table 10 below are mandatory while others are optional.

TABLE 10
Properties of the cooling system functional model.

| Attribute | Definition |
|---|---|
| Cooling mode | ONAN, ONAF, ODAF, OFAF |
| Number of operating fans | Number of operating fans |
| Number of operating pumps | Number of operating pumps |
| Number of radiators banks | Number of radiators |
| Number of Plates | |
| Load currents | Load currents measurement (LV, HV) |
| Fan noise (dB) | Noise emission level |
| Fan speed | Number of fan's rotation per minute |
| Fan diameter | Fan |
| Number of blades | Number of fan's blades |
| Radiator height | Radiator height |
| Upgrade cost | Estimated cost of the materials |
| | required for capacity upgrade. |
| Plates width | |

(g) Load tap changer thermal model: Although this component is not mandatory for the simulation design, the transformer load ability could in some application instances depend on the capacity limitation of the tap changer, and thus would necessitate the inclusion of thermal characteristics of the currents carrying components. Therefore, the properties outlined in Table 11 below are required.

TABLE 11
Properties of the load tap changer functional model.

| Attribute | Definition |
|---|---|
| Active tap position | Current tap position, other than rated |
| | tap position. |
| Oil temperature rise over | Oil temperature rise over ambient |
| ambient | in LTC compartment at per-unit load |
| Contact temperature rise | Contact temperature rise over oil at |
| | rated current |
| Rated tap current | Nominal switching capacity |

(h) Bushing thermal model: In the same line as the tap changer component, the bushing which is also a current carrying component requires the properties outlined in Table 12 below.

TABLE 12
Properties of the bushing functional model.

| Attribute | Definition |
|---|---|
| Immersion oil rise over | Bushing lead immersion oil temperature |
| ambient | rise over ambient at rated load |
| Hot spot temperature rise | Bushing hot spot temperature rise |
| | over oil at rated current |
| Rated bushing current | Rated bushing rated current |
| Bushing constants | Constants specific to bushings |

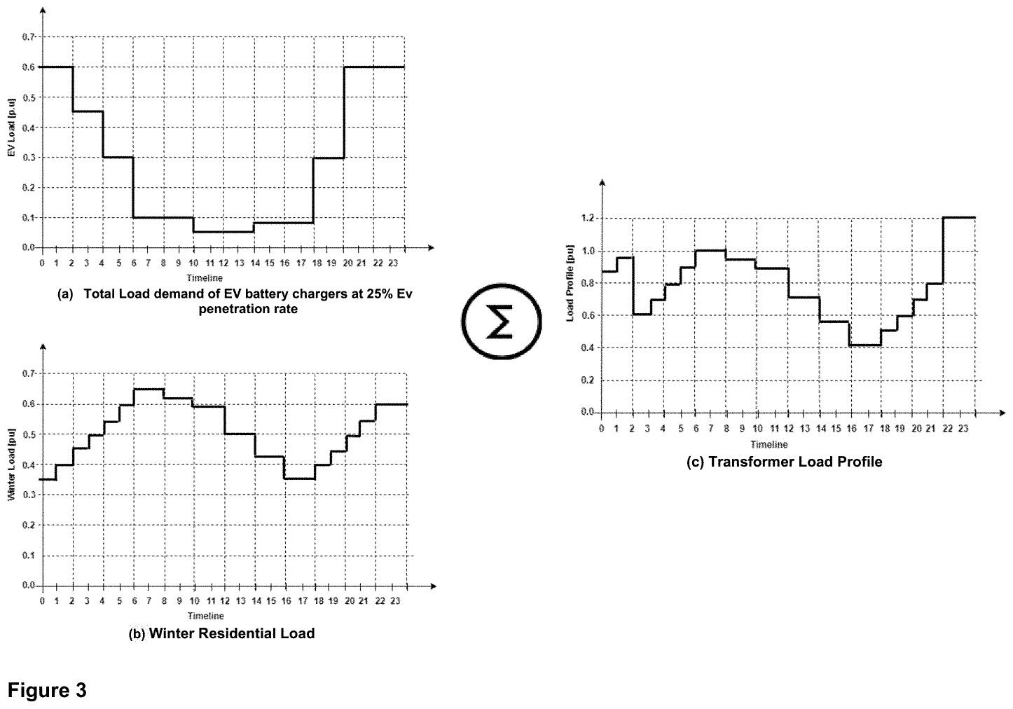

(i) Load profile model: This is a center piece component, since the dynamics resulting from load demand and supply have direct impact on the transformer loading capability. For example, distribution transformers supply various types of residential and industrial loads. With the integration of electric vehicles (EV) and distributed energy resources (e.g., PV) in the power grid, non-linear loads are now superimposed on the traditional residential and industrial loads, and thus create the need to assess the transformer readiness to withstand dynamic fluctuating load. The overall load profile of the transformer becomes a combination of various loads either on the demand or supplied side. The load profile model includes an operator which when provided with various sources of loads merges or remove them in an overall unique load to be submitted. FIG. 3 shows an example of two types of loads: (a) EV battery charging load, and (b) a residential winter daily load profile which are combined to showcase the overall daily load profile ((c)) to be simulated. The load profile component is mandatory, and exposes the properties outlined in Table 13 below.

TABLE 13
Properties of the load profile functional model.

| Attribute | Definition |
|---|---|
| Electric vehicles (EV) | The penetration rates of electric |
| hourly penetration rates | vehicle in the areas |
| | covered by the transformer |
| Distributed energy sources | Timestamped supplied load from |
| integration | distributed energy resources |
| Daily-summer load profile | Array of <timestamp, per unit load> |
| Daily winter load profile | Array of <timestamp, per unit load> |
| Transformer load history | Time stamped file of the transformer |
| | load history |

(j) Dissolved gas and load correlation model: Gas generation in the transformer insulation is another impacting factor to take into consideration when designing a simulation experiment. The properties outlined in Table 14 below are exposed for the simulation of gasses generation impact on the transformer loading capability.

TABLE 14
Properties of the dissolved gas and load correlation functional model.

| Attribute | Definition |
|---|---|
| Gases level | Array of gases level |
| | [symbol] H₂, CO, CO₂, CH₄, C₂H₆, C₂H₄, C₂H₂ [symbol] |
| | at nominal load |
| Rates of gasses increase | Array of rates of gases increase at |
| at nominal load | nominal load |
| Reported gasses levels | Timestamped array of gases levels |
| | measurements |
| Reported rates of gases | Timestamped array of rates of gases |
| increase | increase measurements |

(k) Harmonics: The non-linearity of EV loads inserts high frequency harmonic currents. To protect the transformer from the destructive impacts of high frequency harmonics, incorporating the current harmonics in the loss calculations is essential. This component is not mandatory, but when simulating non-linear loads, the properties outlined in Table 15 below must be specified.

TABLE 15
Properties of the harmonics functional model.

| Attribute | Definition |
|---|---|
| Harmonic currents for | Array of currents |
| residential load | <harmonic rank, Amps> |
| Harmonic currents for | Array of currents |
| industrial load | <harmonic rank, Amps> |
| Harmonic currents for EV load | Array of currents |
| | <harmonic rank, Amps> |
| Harmonic currents for DER load | Array of currents |
| | <harmonic rank, Amps> |

(l) Ambient profile: Ambient temperature is one the impacting factor on the transformer loadability, mainly if its variation during the period under analysis, can be considered significative and/or transformer load is close to nameplate rating. Depending on the site location where the transformer is installed, the ambient temperature will dictate the overall thermal limit it is subjected to.

The weather forecast provides descriptions of different weather behavior allowing the simulation of its impact on the transformer loadability. Especially, with the GPS location data (longitudes, latitudes, and Altitudes), the ambient temperature model provides a nearly accurate allows collecting the site weather forecasts on daily, weekly, and monthly basis. The properties of this mandatory ambient temperature model are outlined in Table 16 below.

TABLE 16
Properties of the ambient profile functional model.

| Attribute | Definition |
|---|---|
| Ambient temperature offset | Ambient temperature shift distribution |
| Daily-summer ambient | Array of <timestamp, average |
| temperature profile | temperature> |
| Daily-winter ambient | Array of <timestamp, average |
| temperature profile | temperature> |
| Weather forecast | Array of <timestamp, daily max-min |
| | temperature> |
| Ambient temperature | Time stamped file of the |
| history | ambient temperature history |

(m) Simulation outputs: The simulation goals are also expressed in terms of statistics collected on outputs of interest. Statistics are collected during the simulation run, and data plot. Table 17 below includes a non-exhaustive list of simulation outputs properties.

TABLE 17
Sample simulation outputs properties.

| Attribute | Definition |
|---|---|
| Marginal load | Amount of additional load the |
| | transformer can carry on top |
| | of the current load |
| Optimum load | Upper limit of the load the |
| | transformer can safely carry |
| Time to reach peaks | Time to reach the maximum |
| (temperatures, temperature | values of a selected output |
| rises, load, losses, loss-of-life, | |
| aging, moisture, etc.) | |
| Min-avg-max-std trends over | Daily min-max range of the |
| time | selected output |
| Min-avg-max trends over | Daily min-max range of the |
| ambient shifts | selected output |
| Min-avg-max (temperatures, | Thermal aging acceleration factor |
| temperature rises, load, losses, | |
| loss-of-life, aging, moisture, etc.) | |
| Limitation factor | Variable causing the transformer |
| | loading limitation |
| Status (deficit, gain) | Daily trend of load margin deficit |
| | or gain |
| User defined outputs | User defined attributes |

When the simulation experiment design is completed and submitted, the front-end server generates a stimuli file which is dropped in the files bucket for scheduled access. The stimuli file contains the following:
1. Simulation time T
2. Transformer profile properties.
3. b the dynamic datasheet.
4. E={s₁, s₂, . . . sₘ} the set of loading scenarios.
5. P={p₁, p₂, . . . pₘ} the set of ambient and load profiles
6. [symbol] ={a, b, c, d, e, f, g, h, i, j} the system models
7. [symbol] the set of targeted simulation outputs

### IV. The Database and the Files Bucket

While the stimuli files bucket is the repository of stimuli files generated from the simulation experiments design, it also hosts the platform log files and simulation trace files for proper system activities monitoring.

The loading platform database: (a) stores the metadata associated with all user accounts and API keys, simulation experiments meta data, and data streamed from external sources; (b) the transformer profiles; (c) the simulation results.

### V. The Simulation Server

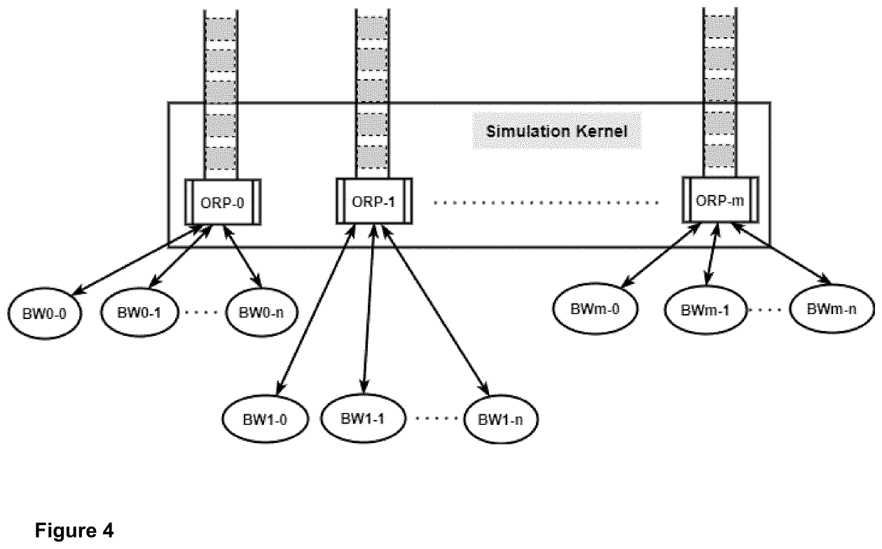

Simulations often require resource-rich machines. The LoadingHub simulations platform according to the invention is no exception and runs on many simulation clusters managed by the simulation kernel shown in FIG. 4. Each transformer simulation session is paired with a cluster consisting of a cluster head orchestrating tasks allocation and the cluster members or background workers (BW) executing the tasks. The Simulation kernel accepts simulation requests from the front-end server for each transformer and starts an orchestration process (ORP) for every new simulation request. The simulation task consists of solving an instance of the Transformer Marginal Load Capability Problem (TMLCP) formulated as a constrained optimization problem where a given time-dependant load profile is scaled up or down by a multiplication scalar F, subject to the operation constraints set forth by the respective loading scenarios defined in the stimuli file. The TMLCP is formulated as follows:

Let:
P: the set of load profiles
E: the set of loading scenarios
dₙ denotes the datasheet of transformer configuration parameters extracted from the heat-run report
vₑ denotes the vector of attributes defined in a loading scenario e ∈E
vₑ^{max} the vector of maximum attributes values
Kₚ denotes the load profile p ∈P

### TMLCP:

f(dₙ, vₑ)=Kₚ(t) for 1≤p≤|P|, 1≤e≤|E|

### Subject to:

vₑ(θₜₒₚ, θₕₒₜ, K, L, . . . )≤vₑ^{max}

Solving the marginal load capability problem consists of finding the optimum vector (vₑ*) that maximizes the marginal load function f(dₙ, vₑ) and satisfying the set of constraints vₑ^{max}. TMLCP is solved using thermal models known in the art such as for example in documents [1] and [2], or a custom-designed thermal model.

### A. The Orchestration Process Node

The ORP node represents each cluster head and is responsible for orchestrating the simulations tasks among the BW nodes, by keeping their shared state synchronized. Especially, the ORP performs five functions, namely, it: (a) approximates the unknown parameter values within the transformer datasheet when their impacts on the transformer loading capability are being assessed, or when they simply cannot be found from the heat-run report; (b) allocates loading scenarios to BW nodes within the cluster; (c) inquires about the running status of the tasks with each member; (d) compiles and merges the results from BWs; (e) relays the results to the kernel for storage in the database.

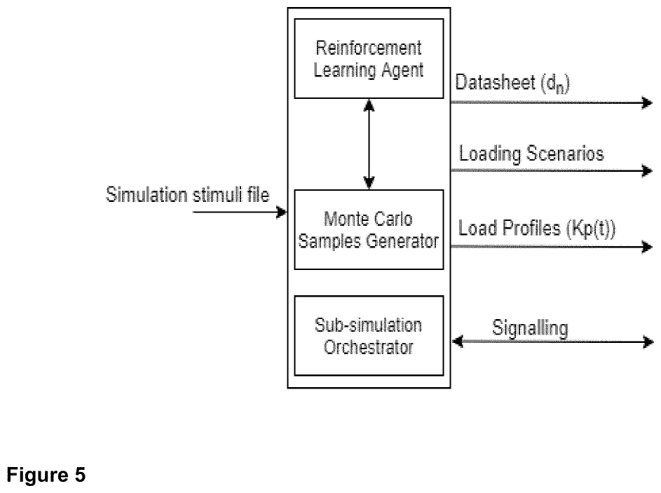

When the simulation server receives a request for a given transformer, the associated stimuli file generated from the complete simulation design is pulled from the disk and fed into the Multivariate Monte-Carlo samples generator. For unknown parameters the generator samples the stimuli file in the light of variables specified as probability distribution (cf. Table 1 for example). FIG. 5 depicts a representation of an ORP functional model.

### 1. The Transformer Datasheet Reinforcement Learning Agent

For simulation sessions where some transformer parameters are unknown or difficult to extract, or subject to impact evaluation on the transformer loading capability, the ORP prior to instantiating and allocating loading scenarios to BW nodes enables its reinforcement learning (RL) agent to perform an approximation of the unknown parameters values with vector sequences randomly generated with a Multivariate Monte Carlo sequences generator [9]. To this end, the transformer datasheet approximation problem is modelled as a Markov Decision Process MDP=(S,A,P,r,γ), where:

State space: S={s₀, s₁, . . . s_{q}}, denotes the state space defined as the set of vectors of unknown parameters in the datasheet configuration. The parameters are encoded as a vector of random variables each represented by either a known distribution or a uniform distribution within known boundaries. The most likely unknown or difficult to extract parameters from the transformer heat-run are usually the transformer losses and temperature rises. Parameters' boundaries could be guess-estimated according to the transformer model, manufacturer, size, and voltage class, or they can be inferred from a sister operating unit or estimated from the transformer monitoring data. Table 18 below provides an example of a state representing unknown parameters and how they are encoded as vector.

TABLE 18
Example of unknown parameters used in a state vector representation.

| Parameter Description | Value | Unit |
|---|---|---|
| Load losses, watts (P _{LL}) | [P _{LLmin}, P _{LLmax}] | Watts |
| Tested or rated average winding rise | [Δθ_{W/A,Rmin}, | K |
| over ambient (Δθ_{W/A,R}) | Δθ_{W/A,Rmax}] | |
| Tested or rated hot spot rise over | [Δθ_{H/A,Rmin}, | K |
| ambient (Δθ_{H/A,R}) | Δθ_{H/A,Rmax}] | |
| Tested or rated top oil rise over | [Δθ_{TO,Rmin}, | K |
| ambient (Δθ_{TO,R}) | Δθ_{TO,Rmax}] | |
| Tested or rated bottom oil rise | [Δθ_{BO,Rmin}, | K |
| over ambient (Δθ_{BO,R}) | Δθ_{BO,Rmax}] | |
| Per unit eddy loss at winding | [p_{EHS}^{min}, P_{EHS}^{max}] | — |
| hot-spot, EHS | | |
| Winding time constant (P_{EHS}) | [τ_{wmin}, τ_{wmax}] | Min. |
| Per unit winding height to hot | [H_{HSmin}, H_{HSmax}] | — |
| spot (H_{HS}) | | |

The associated state vector is encoded as s=[P_{LLmin}, Δθ_{W/A,R}, Δθ_{H/A,r}, Δθ_{TO,R}, Δθ_{BO,R}, P_{EHS}, τ_{W}, H_{HS}]. The nature of some parameters being continuous leads to a large state space and infinite time horizon to come up with an optimal policy. Therefore, the Monte Carlo sequence of states generation is used to discretize the state space to a controllable finite state space.

Action space: a ∈A={a₀, a₁, . . . a_{q}} the set of actions at the agent disposal. Given a sequence of states, taking an action consists of:
(i) picking up a state vector s in the sequence and evaluating the resulting datasheet configuration against the reference Normal Life Expectancy Loading (NLEL, e.g., Table 19 below) scenario, and a continuous load at rated output and rated average ambient temperature. The reference load profile is a constant load (1+δ) p.u., and constant ambient temperature, over a 24-h time period (10⁻⁵≤δ≤10⁻²); the evaluation of a state consists of solving TMLCP until convergence, or not, using a Newton-Raphston or a bisection heuristic for example. TMLCP converges if there exists an optimum solution vₛ* such that ∥vₑ^{max}−vₛ*∥≤∈.
(ii) The agent is allowed to ignore non-converging states.
(iii) Choosing a converging state s as the guess centroid of the list of converging states encountered so far during the generation-evaluation sequences of states.
   Examples of temperature limits for normal life expectancy are outlined in Table 19 below.

TABLE 19
Example—Temperature limits for Normal Life Expectancy [1].

| Limiting Parameters | Value | Unit |
|---|---|---|
| Maximum Top oil temperature | 105 | ° C. |
| Maximum Hot spot temperature | 120 | ° C. |
| Maximum load, percent of maximum | 1.0 | p.u. |
| nameplate rating | | |
| Maximum permissible loss of life | 0.037% | K |

Reward Function: Let Γ(t) denotes the set of converging states encountered up to time t of the generation-evaluation process of the sequence of state vectors {s₀, a₀, s₁, a₁, . . . sₙ}. The agent gets rewarded every time the TMLCP solver converges on a state, and the latter state is used as a guess centroid for the states list Γ(t). The immediate reward upon taking an action aₜ ∈A of picking state s as the guess centroid is quantified as the negative sum of distances between s and its peers in Γ(t), as follows:

$$\begin{matrix}r ( s , {a}_{t} ) = - {\sum }_{k = 0}^{n ( t )} ‖ {s}_{k} - s ‖ , & n ( t ) = \vert Γ ( t ) \vert\end{matrix} \qquad ( 1 )$$

State Value Function: The cumulative reward captured in the state value function over the course of the generated state sequences is a measure of the deviation between the state selected as guess centroid s and the real centroid s*. As the population of converging states s ∈Γ(t) increases, the state-value function is re-evaluated for each state, hence leading to a set of stationary policies. Given a stationary policy π(s)=(a, a, a, a, . . . ), the state value function over the horizon T of the simulation is the expected long-term return at the end of the simulation, and is expressed as follows:

$${V}^{π} ( s ) = 𝔼 [ \begin{matrix}{\sum }_{t = 0}^{T} {γ}^{t} r ( {s}_{t} , {a}_{t} ) \vert {s}_{t} = s ; & π\end{matrix} ] \qquad ( 2 )$$

The discount factory γ is included to extend the definition of the value function to infinitely long trajectories, but in practice is set as γ=1. The Agent will eventually reach a termination state, equivalent in the worst case to the number of Monte Carlo sequences generated, i.e n(t)≤n(T). Hence:

$${V}^{π} ( s ) = - \frac{1}{n} {\sum }_{k = 0}^{n} ‖ {s}_{k} - s ‖ \qquad ( 3 )$$

Optimum Datasheet: The agent's goal is to maximize the cumulative reward it receives in the long run, leading to the optimal centroid vector s* satisfying:

$${s}^{*} = {arg max}_{π ∈ Π} \{ {V}^{π} ( s ) \} \qquad ( 4 )$$

where Π is some policy set of interest. The value function can be optimized using Dynamic Programming or a Value Iteration Algorithm for example [8]. The estimated value of the attributes in the centroid vector s* are plugged back into the datasheet configuration as the newly learnt datasheet template for the studied transformer. For each cooling mode with unknown parameters value, the MDP is solved, and the unknown parameters value are approximated and archived as template inputs for future simulations.

### 2. The Orchestration

The orchestrator instantiates the BW nodes to form the simulation cluster and provision each BW node within the cluster with load calculation inputs such as: the given, or newly learnt transformer datasheet, a loading scenario, and the load and ambient temperature profiles under consideration. Periodically during the simulation run, the orchestrator gets the running status of the tasks with each member. At the completion of a simulation run, the orchestrator merges the results and reports the simulation outcome to the database for storage and presentation. The number of BW nodes is equivalent to the number of loading scenarios in the stimuli file. Each loading scenario is assigned to a BW node within the ORP cluster, leading to a parallel execution and reporting. Every new simulation request to the simulation server enables the instantiation of a new ORP to manage the simulation run. When a simulation session is completed, the associated ORP is killed to free system resources.

### B. The Background Worker Node

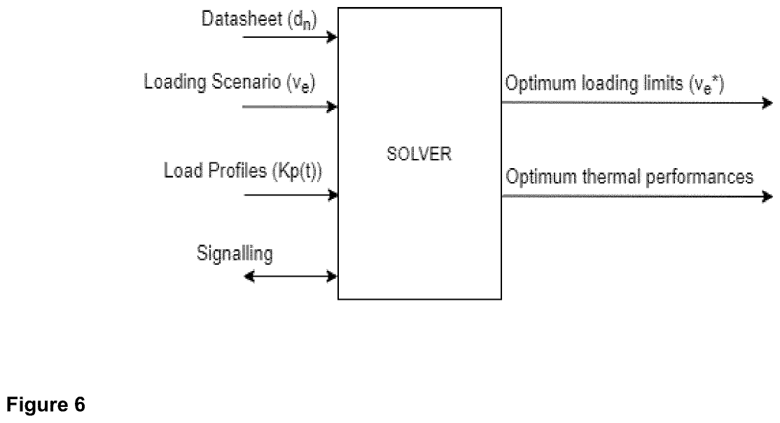

BW nodes are instantiated by an ORP for the number of simulation scenarios defined in the stimuli file. Each BW node runs a solver on the assigned instance of TMLCP and answers back to the ORP. At the completion of the assigned task, the BW node frees the allocated resources and dissolves itself to conserve cloud resources. FIG. 6 depicts a representation of the BW nodes functional model.

The BW outputs results are relayed to the ORP and structured in terms of the attributes (optimal loading limits and thermal performances) outlined in Table 17. These outputs are categorized as optimum limits representing the optimum vector of upper limits of load, temperatures, and aging. The calculation status is a discrete life sign indicating whether a calculation has started, is in progress, or is completed.

### C. Models Librairies

To be able to compute the simulated variables, the BW nodes relies on the library of analytical models that implements the behaviors of the functional components specified in the stimuli file. There are two types of libraries: (a) the transformer functional models library which implements the functional models specified in the Diagram of FIG. 2, as well as the interconnection between them; (b) the library of solvers which implements the optimization Heuristics [7], as well as the Reinforcement Learning Algorithms [8] used for the transformer datasheet approximation.

### D. The Simulation Process Flow

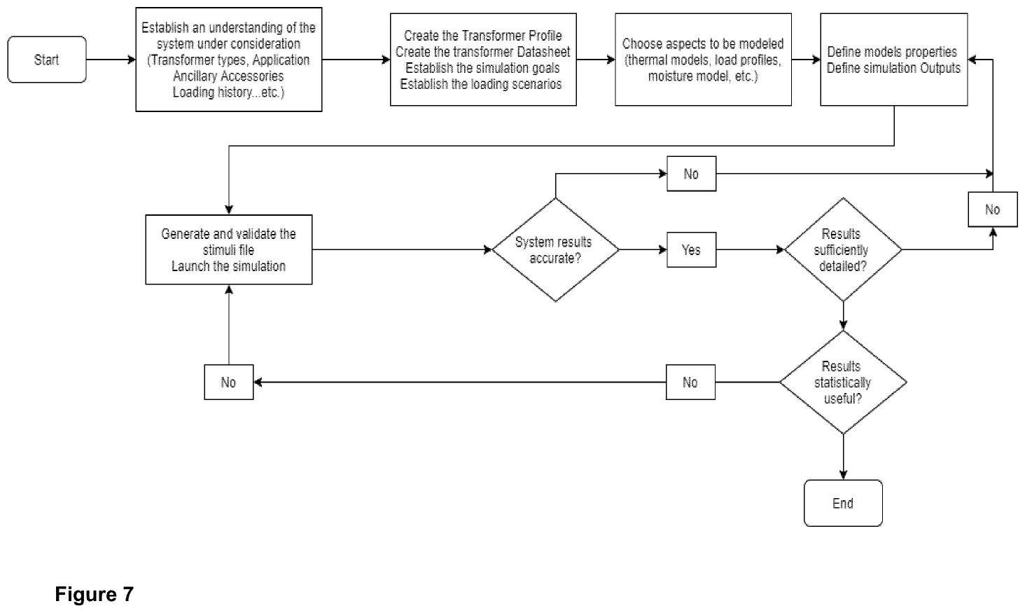

The transformer rating and marginal load simulation process goal is to find the optimal loading policy that fulfill the T&D operational needs expressed in terms of interrogations. The process flow involves the definition of the transformer type and system components interconnected to each other as a chain of functional models. The resulting models is solved as a system of equations to produce selected outputs for questions answering and decision making. FIG. 7 presents the simulation process diagram in terms of steps to follow.

A further embodiment of the invention is described below.

The Transformer Ubiquitous Nameplate (also Referred to Herein as the uNamePlate™)

The ubiquitous nameplate methodology is a passive transformer monitoring methodology which consists of moving the transformer nameplate from its traditional passive role, to a dynamic virtual infrastructure extending its prescription of loading capabilities to the location where the apparatus is installed, the changing climate it is subjected to, and the operation constraints set forth by the actors, the loading guides recommendations [1-2] and the regulation authority constraints [4], by relying solely on the transformer conventional accessories data [7], human inputs, and optionally with a data logging facility.

The uNamePlate proposal according to the invention is a digital infrastructure devised to allow transmission and distribution (T&D) operators and other actors to perform various activities. In embodiments of the inventions, the digital infrastructure:
a. Allows T&D utilities, original equipment manufacturers (OEMs), or any other high voltage (HV) assets owners to register their transformers on a digital portal (cloud-based), preferably with their conventional nameplate and heat-run test report, and accessories date (liquid and winding temperature indicator, etc.).
b. Allows the actors to submit their loading policy requirements to obtain the determination of an optimal loading policy that reliably suits their continuous operation.
c. Enables a continuous verification of their transformers ratings compliances against the guidelines enacted by regulatory bodies [4] and delivers a digital certificate of compliancy for audit.
d. Delivers daily/weekly/monthly load forecast notifications to designated recipients, with the help of location weather data, and custom load profile.
e. Allows transformer OEMs to track the performance of commissioned transformers' thermal performances before, and on site after commissioning, on the operation theater.

Nameplate and heat-run tests results are compiled in a unified datasheet, and the operating ambient conditions adjusted with the help of the GPS coordinates where the equipment site is located, and where the weather data will dictates the transformer marginal load forecast. The transformer registration is performed in three (3) steps with the help of its original static nameplate and heat-run factory final test results (FFTR), where required data inputs are extracted and tabulated, or estimated by the simulation mechanisms described herein above.

### Step 1: Transformer Identification

The transformer is created with the general-purpose information usually found on the stainless-steel nameplate, namely: the transformer name, type, phases, voltage class, liquid and solid insulation type, and most of all its geographic location (referenced by the GPS latitude, longitude, and altitude). The global referenced position of the transformer is mandatory, as it allows the collection of the effective weather forecast pertaining to the location of its installation.

The transformer nameplate reading expressed in terms of its nominal MVA rating, and the corresponding cooling operation modes are also required, as inputs. When the creation is successfully validated, a datasheet is created for the next steps.

### Step 2: Transformer Data Profile

From the previous step, a transformer datasheet is generated.

### The Datasheet

It consists of 4 datasets categorized as follows: mechanical design data, temperatures rise, transformer losses, cooling system configuration, ancillary components configuration, all extracted from the FFTR provided during the equipment commissioning. Certain entries within the datasheet are mandatory while others are optional. When the optional entries are provided, they enhance the accuracy of the marginal load and temperatures forecasts calculation. Supported ancillary components include the transformer tap changer (provided there is one available), bushings, and cablings.

### The Load Profiles and The Transformer Thermal History

The transformer registration also requires minimally a load profile and optionally its thermal history. The load profile can either be seasonal (summer, winter, etc.) or user-defined, provided that, it reflects the T&D operator loading practices on this specific asset. The load profile can either be obtained from the substation historian, or from sensing instrument transformer measuring a timestamped daily load impressed on the transformer.

### The Loading Scenarios

They are specified with the loading scenarios modeler introduced herein above.

The user can define an unlimited number of loading scenarios, and the system will provide the forecasts for each one of them, according to the delivery conditions set forth, in the next step.

### Step 3: QR Code Generation and Load Forecast Delivery Frequency

At this final step, the transformer data profile is submitted to the simulation platform, which responds by providing a unique QR code embedded with a Unified Resource Identifier (URI) confirming the transformer registration. The QR code must be downloaded and permanently saved in a place where it can be accessed every time, everywhere, on any mobile device equipped with a scanning capability. The delivery frequency, which is set to “on-demand” by default, along with the recipients addresses, allows the actors to get the transformer marginal load forecast, and thermal performances delivery either upon request, or at a specified period which may be selected among: daily, weekly, bi-weekly, and monthly.

The uNamePlate Infrastructure

The uNamePlate infrastructure system consists of three (3) parts as follows:
(a) A portal where actors register their transformers with the information and steps described herein above.
(b) The nameplate calculation center (NCC) located within the simulation server acting as gateway where the load forecast calculation and the thermal performance evaluation are conducted, a comprehensive forecast report is generated, and the notification and delivery schedule are executed. When the transformer thermal history is provided, its thermal model can be learnt and used as de-facto thermal model for the full transformer monitoring.
(c) A QR code generated from the successful registration is issued. The code embeds a combination of the calculation center URL (Unified Resource Locator), and a global unique identifier XFMRId allocated to the transformer by the NCC during the registration process. The QR code is delivered to the actor and allows spontaneous marginal load forecast request, or a modification request.

A notification scheduler (NS) which purpose is to issue the load forecast delivery report according to the plan selected during the registration process. The notification content is delivered as a dynamic html report including actionable controls allowing the user to modify the inputs specified at Step 2 (load profiles, loading scenarios), whenever required. Occurrences where these items are modified happen when the transformer load profile has changed due to operation constraints, or when the operation constraints are changed because current thermal limits are no longer applicable or need to be modified for operational purposes.

In embodiments of the invention, a system is provided, which comprises the scalable simulation platform according to the invention and/or the ubiquitous transformer nameplate according to the invention. The system may also be cloud-based.

As will be understood by a skilled person, other variations and combinations may be made to the various embodiments of the invention as described herein above.

The scope of the claims should not be limited by the preferred embodiments set forth in the examples; but should be given the broadest interpretation consistent with the description as a whole.

The present description refers to a number of documents, the content of which is herein incorporated by reference in their entirety.

### REFERENCES

[1] “IEEE Guide for Loading Mineral-Oil-Immersed Transformers and Step-Voltage Regulators,” in IEEE Std C57.91-2011 (Revision of IEEE Std C57.91-1995), pp.1-123, Mar. 7, 2012, doi: 10.1109/IEEESTD.2012.6166928.

[2] IEC, 2005, “IEC 60076-7:2005 power transformers—part 7: Loading guide for oil-immersed power transformers” vol. 60076-7.

[3] https://www.epri.com/research/products/1015249, accessed Mar. 30, 2021.

[4] NERC Standard FAC-008-1 — Facility Ratings Methodology, 2005.

[5] “IEEE Standard for General Requirements for Liquid-Immersed Distribution, Power, and Regulating Transformers,” in IEEE Std C57.12.00-2015 (Revision of IEEE Std 057.12.00-2010), pp.1-74, May 12, 2016, doi: 10.1109/IEEESTD.2016.7469278.

[6] “IEEE Standard for the Design, Testing, and Application of Liquid-Immersed Distribution, Power, and Regulating Transformers Using High-Temperature Insulation Systems and Operating at Elevated Temperatures,” in IEEE Std C57.154-2012, pp.1-49, Oct. 30, 2012, doi: 10.1109/IEEESTD.2012.6357332.

[7] Bertsekas, D. P. (2016). Nonlinear programming. 2^{nd} Edition (1995).

[8] Bertsekas, D. P. Reinforcement Learning And Optimal Control Book, Athena Scientific; 1^{st} Edition (Jul. 15, 2019).

[9] C. P. Robert and G. Casella, Monte Carlo Statistical Methods, 2^{nd} Edition, (Springer, New York, 2004.

1. A scalable simulation platform, comprising means for rating a power transformer, means for setting a loading policy for a transformer, and/or means for evaluating the thermal performances of a transformer.

2. The scalable simulation platform according to claim 1, which is adapted for simulating: heat-run test configurations, loading capability, thermal performances, capacity upgrade, and combinations thereof.

3. The scalable simulation platform according to claim 1, comprising: a front-end server, a simulation designer, a database and file bucket, and a simulation server.

4. The scalable simulation platform according to claim 3, wherein the front-end server is adapted for coordinating actions between power system actors involved in the decision-making process; preferably the actions are selected from the group consisting of:
authentication, transformer registration, data streaming and formatting, and simulation initialization and monitoring.

5. The scalable simulation platform according to claim 4, wherein the power system actors are selected from the group consisting of: maintenance and planning engineers, load dispatchers, high voltage asset managers or owners, original equipment manufacturers (OEMs), and transformer monitoring service providers.

6. The scalable simulation platform according to claim 3, wherein the simulation designer is a web console embodying model constructs; preferably the model constructs are selected from the group consisting of: transformer dynamic datasheet, loading scenario modeler, and virtual transformer designer.

7. The scalable simulation platform according to claim 3, wherein the database and file bucket is adapted for storing at least one of: metadata associated with all user accounts and application programming interface (API) keys, simulation experiments metadata, and data streamed from external sources; transformer profiles; and simulation results.

8. The scalable simulation platform according to claim 3, wherein the simulation server embodies one or more simulation clusters.

9. The scalable simulation platform according to claim 1, which is cloud-based.

10. A method for rating a power transformer, for setting a loading policy for a transformer, and/or for evaluating the thermal performances of a transformer, the method comprising simulation of one or more of: heat-run test configurations, loading capability, thermal performances, and capacity upgrade.

11. A method for rating a power transformer, for setting a loading policy for a transformer, and/or for evaluating the thermal performances of a transformer, the method comprising using the scalable simulation platform as defined in claim 1.

12. Use of the scalable simulation platform as defined in claim 1, for rating a power transformer, for setting a loading policy for a transformer, and/or for evaluating the thermal performances of a transformer.

13. A ubiquitous transformer nameplate, which embodies a digital infrastructure system allowing for the transformer nameplate to be moved from its traditional passive role to a dynamic virtual infrastructure.

14. The ubiquitous transformer nameplate according to claim 13, wherein the digital infrastructure system comprises:
means for allowing power system actors to register their transformers on a digital portal (preferably the digital portal is cloud-based), preferably with their conventional nameplate and heat-run test report, and accessories data such as liquid ad winding temperature indicator;
means for allowing the power system actors to submit their loading policy requirements to obtain the determination of an optimal loading policy that reliably suits their continuous operation;
means for enabling a continuous verification of transformers ratings compliances against the guidelines enacted by regulatory bodies, and deliver a digital certificate of compliancy for audit;
means for delivering daily/weekly/monthly load forecast notifications to the actors or designated recipients, with the help of location weather data, and custom load profile; and/or
means for allowing the tracking of the performance of commissioned transformers' thermal performances before and on site after commissioning, on the operation theater.

15. The ubiquitous transformer nameplate according to claim 13, wherein the digital infrastructure system comprises: a portal adapted for the registration of transformers; and a simulation server embodying a nameplate calculation center (NCC).

16. The ubiquitous transformer nameplate according to claim 15, wherein the nameplate calculation center comprises:
means for generating a QR code for each transformer;
means for conducting the load forecast calculation and the thermal performance evaluation of the transformer;
means for generating a comprehensive forecast report for the actors; and/or means for executing a notification and delivery schedule.

17. The ubiquitous transformer nameplate according to claim 14, wherein the power system actors are selected from the group consisting of: maintenance and planning engineers, load dispatchers, high voltage asset managers or owners, original equipment manufacturers (OEMs), and transformer monitoring service providers.

18. The ubiquitous transformer nameplate according to claim 13, which is cloud-based.

19. A system comprising the scalable simulation platform as defined in claim 1, optionally which is cloud-based.

20. A system comprising the ubiquitous transformer nameplate as defined in claim 13, optionally which is cloud-based.
